(19) United States
(12) Patent Application Publication
(10) Pub. No.: US 2010/0036725 A1
(43) Pub. Date: Feb. 11, 2010

(54) METHOD AND SYSTEM FOR PROVIDING A PREDETERMINED SERVICE TO A DOMAIN REGISTRANT BY A TLD REGISTRY

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/519,858

(22) PCT Filed: Jun. 9, 2008
(86) PCT No.: PCT/IN2008/000362

§ 371 Date: Jun. 18, 2009

(30) Foreign Application Priority Data
Jun. 7, 2007 (IN) 1085/MUM/2007

(51) Int. Cl. G06Q 30/00; G06Q 10/00; G06F 15/173; G06Q 50/00

(52) U.S. Cl. 705/14.39; 705/14.69; 705/14.7; 705/34; 709/224

(57) ABSTRACT

The present invention relates to a method and system for providing a predetermined service to a domain registrant by a TLD registry through a first service provider The first service provider is required to be used for the predetermined service (105) by returning a first DNS result, which comprises DNS records corresponding to servers of the first service provider, in response to a DNS query to a DNS server of the TLD registry (110). The DNS query is a request for a service provider of the predetermined service for the domain name. Alternatively, a DNS of the domain name can be delegated to a first set of name servers controlled by the TLD registry and/or the first service provider (115). The first set of name servers returns the first DNS result in response to a DNS query for a service provider of the predetermined service. Further, if the DNS is managed by the domain registrant, it can be monitored if a DNS response of the domain name is the first DNS result (120).

### FIELD OF THE INVENTION

The invention relates generally to providing a predetermined service to a domain registrant and, more specifically, to method and system a TLD registry and a service provider can use to provide the predetermined service through a service provider affiliated with the TLD registry.

### BACKGROUND OF THE INVENTION

Various Internet services nowadays are provided free, with the revenue model being, building an audience and selling advertisement. One of the most common services of this type is free email. Until recently free email was provided chiefly to individuals. But recently free email services are now also being provided to businesses at their own domains. Businesses generally prefer having email services at their own domain names. For example, an XYZ company can register a domain name for their company's web presence as XYZ.com or XYZ.net and would want email addresses for all their employees of the type employee_name@xyz.com.

A domain name consists of two parts—the top level domain name (TLD) and the second level domain name or the host name. For instance, in the case of XYZ.COM the TLD part is .com or .net and the XYZ would be the second level domain name or the host name. Every domain name is registered with a TLD Registry. For instance, XYZ.com is registered with the .com TLD which is controlled by Verisign. There are two types of TLD Registries—gTLD Registry (generic TLD Registry) and ccTLD Registry (country code TLD Registry). A gTLD registry manages domain registrations in general TLDs like .info, .com, .net, .biz etc. A ccTLD registry manages registrations in country code TLDs like .in, .uk, .au etc. Each registry is maintained by a company designated as the official Registry for that TLD. The appointment of the designated company and recognition is done by International Corporation of Assigned Names and Numbers (ICANN) in case of gTLDs and the local government of the country in case of ccTLDs.

Registries generally charge an annual fee to businesses and individuals who wish to register domain names. Registries may directly sell such domain names to end consumers, or they may sell the same through a network of Partners—known as Registrars, who act as channel partners for that Registry. Registrars are typically responsible for sales, billing and customer support for their customers. Typically, Registrars may also provide email service or other services to such a customer for a certain fee. The DNS of a domain name is delegated by the TLD Registry and thus a TLD Registry can control the same. This patent describes method and system in which a TLD Registry can implement its DNS service in a manner so as to provide a service to a domain registrant and earn revenue from that service.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a flow diagram of a method for providing the predetermined service to the domain registrant by the TLD registry through the service provider, in accordance with the present invention.

FIG. 2 illustrated a block diagram of a system for providing a predetermined service to a domain registrant, in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to providing a predetermined service to a domain registrant by a TLD registry. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing a predetermined service to a domain registrant by a TLD registry described herein. The non-processor circuits may include, but are not limited to, a radio receiver, a radio transmitter, signal drivers, clock circuits, power source circuits, and user input devices. As such, these functions may be interpreted as steps of a method and system for providing a predetermined service to a domain registrant by a TLD registry. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to a method and system of providing a predetermined service to a domain registrant by a TLD registry. Those skilled in the art shall appreciate that the methods and system used in the present invention are merely exemplary and are not used to restrict the scope of the invention in any manner. The TLD registry can by affiliated with a service provider to provide the predetermined service to the domain registrant. The predetermined service can be provided free of cost or can be provided at lower costs to the domain registrant. The predetermined service can be any service such as an email service, a chat service, a VoIP service etc. Correspondingly, the service provider can be an email service provider, a chat service provider, a VoIP service provider etc. In an embodiment, the service provider may not be an independent entity and can be the TLD registry itself. All such methods of providing add-on services by the TLD registry through a service provider to a domain registrant, who registers a domain name with the TLD registry, is within the scope of the present invention.

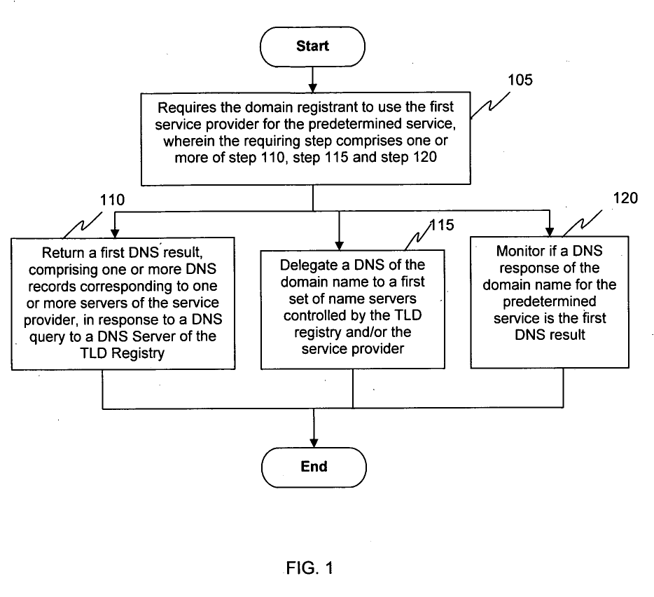

Turning now to FIG. 1, a flow diagram of a method for providing the predetermined service to the domain registrant by the TLD registry through the service provider is shown in accordance with the present invention. As mentioned earlier, the TLD registry may wish to provide a predetermined service such as, but not limited to, an email service, a chat service etc, as value-added services to domain registrants who register domain names with the TLD registry. For instance, a domain registrant may register a domain name, <domainname>.com with the .com registry. In accordance with various embodiments of the present invention, the .com registry may provide the domain registrant with an email service, where the domain registrant can allow a plurality of users to use email addresses of the form <username>@<domainname>.com. Those skilled in the art will appreciate that such value-added services are generally provided by Registrars and Hosting Companies and not TLD Registries.

The TLD Registry can partner with a service provider to provide the predetermined service to the domain registrants as an additional value added service. In an embodiment, the service provider can be the TLD Registry itself.

In accordance with the present invention, the domain registrant is required to use the service provider for the predetermined service at step 105. Thus, if the predetermined service is email service, then the present invention ensures that the domain registrant uses a service provider partnered with the TLD registry for the email service.

Once the business considerations have been determined, the TLD Registry and the service provider can use multiple implementation models described below to provide the predetermined service and make their relationship profitable. Each TLD Registry can choose to operate on a different model and those skilled in the art shall appreciate, that the models described below are merely exemplary and all models relating to TLD Registry providing the predetermined service are within the scope of the present invention. Those skilled in the art shall also appreciate that the models and implementations described below are mutually exclusive, and that one or more of them maybe implemented together. Each such model is explained in conjunction with step 110, step 115 and step 120 of FIG. 1 below.

Each TLD Registry operates TLD DNS Servers which are authoritative for that TLD and contain delegation entries for the DNS zone represented by the TLD. For instance the .com Registry manages DNS Servers which contain delegation entries for all the .com domain names in the world. These TLD DNS Servers receive a query for resolving any domain name within that TLD. At step 110, in response to such a DNS query, a first DNS result is returned. The first DNS result comprises one or more DNS records corresponding to one or more servers of the service provider. The first DNS result can include, but is not limited to, a Mail Exchanger (MX) record, an Service location (SRV) record, an Address (A) record, a IPv6 Address (AAAA) record, a Canonical name (CNAME) record, a Text (TXT) record, a Pointer (PTR) record and a Name Server (NS) record.

Thus, if a DNS query for an email service for a domain name is received at the TLD registry, the TLD registry can return one or more MX records pointing to one or more mail servers of an email service provider partnered with the TLD registry. Those skilled in the art will know that an MX record is a type of resource record in the Domain Name System (DNS) specifying the servers which handle the email for a particular domain name. Hence, when an XYZ company registers a domain name XYZ.com, the TLD Registry can ensure that a response to an MX record query for XYZ.com is always returned by the TLD Registry directly, and directed to the email service provider's infrastructure.

Since a typical DNS server, would not provide a response to an MX query or an A record query, if the domain is delegated by it to another set of DNS Servers, in this case, to implement this method, a special customized DNS server would need to be operated by the TLD registry. In order to minimize the implementation time, the above logic maybe implemented on a separate computing device or software, and DNS traffic to the TLD Registry maybe routed through or made to pass through such computing device or software, which performs the above described operation for the DNS queries of domain names for which the predetermined service is enabled, while the remaining queries may be forwarded to a standard TLD Registry DNS Server as is.

The above process maybe performed for any predetermined service. So for instance a Registry can ensure that the SRV record for Extensible Messaging and Presence Protocol (XMPP) service for the domain name always points to a particular service provider only. If a DNS query is received for a service, which is other than the predetermined service, then the TLD registry can respond with the actual authoritative nameservers that are controlled by the domain registrant.

The above process maybe performed at the TLD Registry's main DNS Servers, or an alternative set of DNS servers controlled by the TLD registry and/or the service provider. controlled by the TLD registry and/or the service provider to which the TLD registry can delegate a DNS of the domain name. These DNS Servers can implement the above described process and return DNS records of the one or more servers of the service provider whenever they are queried for DNS records of the predetermined service for the domain name.

In one embodiment, the domain registrant maybe allowed to add his own DNS records in such alternative set of DNS Servers as long as they do not conflict with the records that point to the service provider for the predetermined service.

In another embodiment, the TLD registry may allow the domain registrant to completely control the DNS of the domain name. However, the TLD registry or the service provider monitors, at step 120, if a DNS response of the domain name for the predetermined server is the first DNS result which comprises the one or more DNS records corresponding to the one or more servers of the service provider. The monitoring can be done by a program or a script. If the DNS response includes result other than the first DNS result, then the TLD registry or the service provider can send a notification to the domain registrant to change the DNS response to the first DNS result. Alternately, the TLD registry or the service provider can suspend the domain name registered by the domain registrant or can levy an extra charge on the domain registrant for the domain name. Those skilled in the art shall appreciate that these models are mutually exclusive, and that one or more of them maybe implemented together.

In an embodiment, the domain registrant may be given an option to opt out of using the service provider for the predetermined service. This can be done by providing an interface setting or an Application Programming Interface (API) query that allows the domain registrant to opt out of the predetermined service. The TLD registry or the service provider may incentivize the domain registrant to continue using the service provider for the predetermined service, for example, by giving the domain registrant a discounted pricing.

Domain registrant that wish to use an independent service provider can get charged a higher fee for registering the domain name while those domain registrants that use the predetermined services provided by the service provider affiliated with the TLD registry can get charged a lower fee for their domain name. Alternatively, TLD Registries may follow a liberal approach where every domain registrant is provided the ability to set or control their own DNS records. Those domain registrants who would like to use the service provider's predetermined service can request a change in their setting or can directly insert the service provider's DNS records in their domain name.

Further, the TLD Registry may also provide, to the service provider a list of domain names for which the service provider can provide the predetermined service. The service provider can, instead, simply provide predetermined service for all domain names registered under that TLD Registry without requiring such a list. Once a domain registrant decides to use the service provider for the predetermined service and changes the DNS record to that of the service provider's servers, the service provider can begin providing the predetermined service to that domain name. Those skilled in the art shall appreciate that several TLD's (gTLD and ccTLD) may be using the predetermined service provided by the service provider and may be implemented differently with different arrangements.

The service provider may provide the predetermined service to domain registrants free of cost, and earn revenue through advertising within the predetermined service, such as in an email service, or through charging the domain registrant or by entering into any other form of commercial arrangement with the TLD registry or the domain registrant. Revenue can be earned by displaying commercial content, such as advertisements or informative messages, to users or when the users click on such commercial content.

As disclosed previously, the TLD Registry and the service provider can enter into an arrangement whereby the service provider gives the TLD Registry a commission for all domain names within that TLD registry, whose DNS records have been set to the service provider's servers. Some TLD Registries may also sell domain names through Registrars and hence may wish to share the revenue of a domain name with the appropriate Registrar as well. Often Registrars may in turn have further channel partners of their own who they wish to share revenue with.

As per one embodiment, in order to share revenue, the service provider may pay a commission to the TLD Registry per domain name that uses the service provider's DNS records. The TLD Registry can then decide the method of distributing the revenue to the Registrars and, in turn, the Registrars channel partners. The service provider can provide the TLD Registry with a periodic report of the domain-wise distribution of the commission earned by the TLD Registry, based on predetermined business arrangement between the service provider and the TLD Registry. The TLD Registry can then in turn distribute the revenue proportionately to the Registrars. The service provider can also handle the distribution of a portion of the commission to the Registrars on behalf of the TLD Registry on receiving instructions from the TLD Registry.

The service provider can provide the periodic report to the TLD Registry to enable the TLD Registry to in turn share revenue with its Registrars. The periodic report can be generated for each domain name using the revenue generated by the predetermined service on that domain name.

The periodic report can be calculated by the service provider as follows. The service provider can earn revenue through advertising, by displaying commercial content to users of the predetermined service or by charging a fee for the service provider to the domain registrant. For the former, for each commercial content displayed, the revenue maybe earned for the display, click OR some other such model. A software system of the service provider can record the revenue earned through display of commercial content on a per user and per domain name basis, by tracking every revenue opportunity using a unique identifier per user and per domain name. Additionally, the service provider can also track revenue charged to each user of the predetermined service or the domain name. This may then be consolidated in the form of periodic revenue reports per domain name. From this the service provider can determine the amount of revenue to be shared with the TLD Registry on a per domain name basis based on the business process used by the service provider to compute the revenue. The periodic report can then be provided to the TLD Registry. The service provider can give the commission to the TLD registry in form of a revenue share or a fixed fee.

As mentioned, the service provider may distribute revenue to the Registrars on behalf of the TLD Registry. For this purpose, the TLD Registry can provide, to the service provider, an indication of a set of domain names that belong to a Registrar, a period for which the set of domain names belong to the Registrar and/or a percentage of the revenue earned out of the set of domain names to be paid to the Registrar. If the Registrar of a domain name changes, for a particular period, the TLD Registry can provide this information to the service provider.

Alternatively, the TLD Registry could calculate a revenue share for the Registrars using a revenue share algorithm and can simply instruct the service provider to make the payments by providing the necessary payment information. In an embodiment, the TLD registry may determine an absolute revenue for each Registrar and send it to the service provider for making the payouts. The TLD Registry may also specify a maximum limit of revenue to be paid per domain name to the Registrars, or per Registrar and the service provider can make payments to the Registrars accordingly. The balance can be transferred to the TLD Registries.

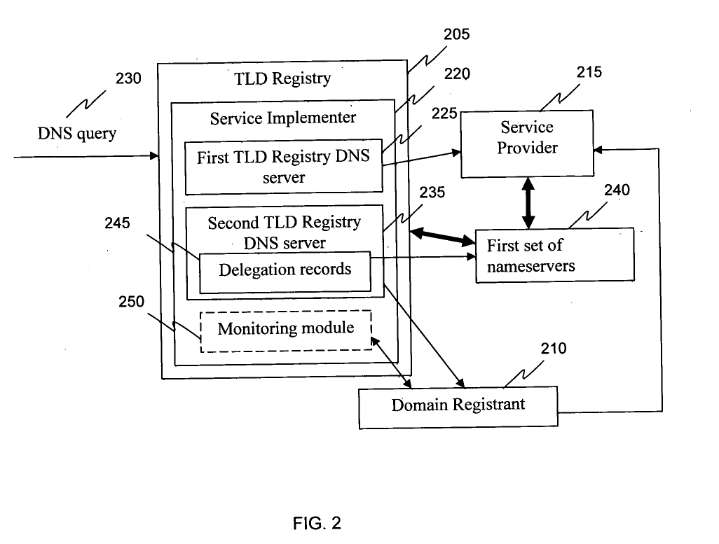

Turning now to FIG. 2, a block diagram of a system for providing a predetermined service to a domain registrant is shown in accordance with an embodiment of the present invention. The system includes a TLD registry 205 which registers domain names for a domain registrant 210 for the respective TLD, such as .com, .net etc. TLD registry 205 may partner with a service provider 215 to provide a predetermined service, either free of cost or for a discounted price to domain registrant 210. As mentioned earlier, service provider may be the TLD registry itself or may be an independent service provider providing the predetermined service.

TLD registry 205 may provide the predetermined service of service provider 215 by default to each domain registrant registering a domain name with TLD registry 205 or can provide it to a set of domain registrants. Further, TLD registry 205 may allow domain registrant 210 to modify DNS records to use a different service provider for the predetermined service.

TLD registry 205 may charge a domain registrant less for registering a domain name, if a domain registrant uses service provider 215 for the predetermined service. Alternatively, TLD registry 205 may charge a domain registrant more for registering a domain name, if the domain registrant does not use service provider 215 for the predetermined service.

The system further comprises a service implementer 220, which ensures that domain registrant 210 uses service provider 215 for the predetermined service. In one embodiment, service implementer 220 can include a first TLD Registry DNS server 225. First TLD Registry DNS sever 225 is configured to return a first DNS result in response to a DNS query 230. As mentioned earlier, in conjunction with FIG. 1, the first DNS result comprises one or more DNS records corresponding to one or more servers of service provider 215. The first DNS result can include, but is not limited to, a Mail Exchanger (MX) record, an Service location (SRV) record, an Address (A) record, a IPv6 Address (AAAA) record, a Canonical name (CNAME) record, a Text (TXT) record, a Pointer (PTR) record and a Name Server (NS) record.

For instance, if DNS query 230 for an email service for a domain name is received at TLD registry 205, first TLD Registry DNS server 225 can return one or more MX records pointing to one or more mail servers of service provider 215.

In order to minimize the implementation time, function of first TLD Registry DNS server 225 may be implemented on a separate computing device or software, and DNS traffic to TLD Registry 205 maybe routed through or made to pass through such computing device or software, which performs the above described operation for the DNS queries of domain names for which the predetermined service is enabled, while the remaining queries may be forwarded to a standard TLD Registry DNS Server as is.

In an embodiment, domain registrant 210 is not allowed to modify the first DNS result. That is, in the above example, domain registrant 210 cannot modify the MX record to point to mail servers of other service providers. In another embodiment, domain registrant 210 is allowed to add a new DNS result to first TLD Registry DNS server 225, but TLD registry 205 ensures that the first DNS result always takes precedence over the new DNS result for the predetermined service.

If a query is received for a service, which is other than the predetermined service, then service implementer 220 can return a second set of nameservers that are controlled by the domain registrant.

In an embodiment, instead of, or in addition to, first TLD Registry DNS server 225, service implementer 220 includes a second TLD Registry DNS server 235. Second TLD Registry DNS server 235 can delegate a DNS of the domain name to a first set of nameservers 240 controlled by TLD registry 205 and/or service provider 215. First set of nameservers 240 may then contain information regarding the DNS records of the one or more servers of service provider 215 and can return the first DNS result. Thus, in the previous example, instead of directly returning the MX records, TLD registry 205 may return delegation records 245 of first set of nameservers 240 which contain the MX records corresponding to the one or more mail servers of service provider 215.

In one embodiment, service implementer 220 gives domain registrant 210 the permission to modify DNS records in first set of nameservers 240 as long as the DNS records modified by domain registrant 210 do not conflict with the DNS records that point to the service provider for the predetermined service. In another embodiment, domain registrant 210 is given the permission to enter one or more DNS records, such as A records, CNAME records etc., in first set of nameservers 240, however, it is ensured that the first DNS result in first set of nameservers 240 is not replaceable by the new DNS records added by domain registrant 210 or that the first DNS result has a higher priority than the new DNS records added by domain registrant 210. The DNS records for the predetermined service for the domain name may be redirected to DNS records corresponding to the one or more servers of the service provider 215 by default.

In another embodiment, service implementer 220 may allow domain registrant 210 to control the DNS of the domain name. However, a monitoring module 250 monitors if a DNS response for the predetermined service for the domain name is the first DNS result which comprises the one or more DNS records corresponding to the one or more servers of service provider 215. If the DNS response includes a result other than the first DNS result, then monitoring module 250 can send a notification to domain registrant 210 to change the DNS response to the first DNS result. Alternately, monitoring module 250 can suspend the domain name registered by domain registrant 210 or can levy an extra charge on domain registrant 210 for the domain name. Those skilled in the art shall appreciate that these models are mutually exclusive, and that one or more of them maybe implemented together.

In an embodiment, TLD registry 205 can give domain registrant 210 an option to opt out of using service provider 215 for the predetermined service. For this purpose, TLD registry 205 can provide an interface setting or an Application Programming Interface (API) query that allows domain registrant 210 to opt out of accessing the predetermined service using service provider 215. TLD registry 205 or service provider 215 may incentivize domain registrant 210 to continue using service provider 215 for the predetermined service, for example, by giving domain registrant 210 a discounted pricing.

Those skilled in the art will appreciate that first TLD Registry DNS server 225, second TLD Registry DNS server 235 and monitoring module 250 can be operatively coupled to a TLD registry server, an independent server, a separate computing device and/or service provider 215.

Various embodiments of the present invention enable a TLD registry to provide a predetermined service, such as an email service, a VoIP service, a chat service etc., to a domain registrant free of cost or for a discounted price. The present invention also enables a TLD registry and a service provider to generate revenue by displaying commercial content on a predetermined service which is provided free of cost or for a discounted price to a domain registrant.

What is claimed is:

1. A method for providing a predetermined service to a domain registrant by a TLD registry, through a first service provider, the predetermined service requiring use of one or more Domain Name System (DNS) records, the domain registrant registering a domain name with the TLD registry, the method comprising:
requiring the domain registrant to use the first service provider for the predetermined service, wherein the requiring step comprises one or more of:
returning a first DNS result in response to a DNS query to a DNS Server of the TLD Registry, wherein the DNS query is a request for a service provider of the predetermined service for the domain name, the first DNS result comprising one or more DNS records corresponding to one or more servers of the first service provider;
delegating a DNS of the domain name to a first set of name servers controlled by one or more of the TLD registry and the first service provider, wherein the first set of name servers return the first DNS result in response to a DNS query for a service provider of the predetermined service; and
monitoring if a DNS response of the domain name for the predetermined service is the first DNS result, wherein a DNS of the domain name is managed by the domain registrant.

2. The method of claim 1, wherein the domain registrant is given an option of opting out of using the first service provider for the predetermined service.

3. The method of claim 2, wherein the TLD registry provides one or more of an interface setting and an Application Programming Interface (API) query to allow a domain registrant to opt out of the predetermined service.

4. The method of claim 2, wherein the domain registrant is incentivized to continue using the first service provider.

5. The method of claim 4, wherein the incentive is a discounted pricing.

6. The method of claim 1, wherein the first service provider is one or more of the TLD registry and an independent service provider.

7. The method of claim 1, wherein the predetermined service is one or more of an email service, a chat service and a VoIP service, the first service provider is one or more of an email service provider, a chat service provider and a VoIP service provider, the first DNS result comprises one or more of an MX record, an SRV record, an A record, a AAAA record, a CNAME record, a TXT record, a PTR record and an NS record.

8. The method of claim 1, wherein one or more of the TLD registry and the first service provider disallows the domain registrant from modifying one or more of the first DNS result and the delegation.

9. The method of claim 1, wherein the domain registrant is given an option to enter one or more DNS records in the first set of name servers, wherein one or more of the first DNS result is irreplaceable by the one or more DNS records and the first DNS result has a higher priority than the one or more DNS records.

10. The method of claim 1, wherein the returning step further comprises:
returning a second set of name servers for a query that is different from the DNS query for the predetermined service, wherein the second set of name servers are controlled by the domain registrant.

11. The method of claim 1, wherein in the returning step, the requiring step and the monitoring step is performed by one or more of a TLD registry server, an independent server, a separate computing device, the first service provider and a program.

12. The method of claim 1, wherein in the monitoring step, if the DNS Response is not same as the first DNS result, then at least one of the TLD registry and the first service provider performs one or more of:
sending a notification to the domain registrant to change the DNS Response to the first DNS result;
suspending the domain name registered by the domain registrant from the TLD registry; and
levying an extra charge for the domain name registered by the domain registrant.

13. The method of claim 1, wherein one or more of the TLD registry, the first service provider and the domain registrant generates a revenue from the predetermined service by performing one or more of:
displaying one or more commercial content to one or more users of the service;
clicking on one or more commercial content by the one or more users of the service; and
charging the domain registrant for the service.

14. The method of claim 13, wherein if the first service provider generates the revenue, the first service provider gives the TLD registry a commission in form of one or more of a revenue share and a fixed fee, for each domain name that uses the predetermined service.

15. The method of claim 14, wherein the first service provider maintains a periodic report of the commission

16. The method of claim 15, wherein the periodic report is generated for each domain name using the revenue generated by the each domain name.

17. The method of claim 15, wherein the periodic report enables one or more of the TLD registry and the first service provider to share the revenue with a Registrar, wherein the domain registrant registers the domain name with the TLD registry through the Registrar.

18. The method of claim 17, wherein to enable the first service provider to share the revenue with the Registrar, the TLD Registry performs one or more of:
providing the first service provider with an indication of one or more of a set of domain names belonging to the Registrar, a period for which the set of domain names belong to the Registrar, and a percentage of the revenue earned out of the set of domain names to be paid to the Registrar;
calculate a revenue share for the Registrar based on a revenue share algorithm; and
determine an absolute revenue for each Registrar.

19. The method of claim 17, wherein the Registrar shares the revenue with one or more registrar channel partners.

20. A system for providing a predetermined service to a domain registrant, the predetermined service requiring use of one or more Domain Name System (DNS) records, the system comprising:
a first service provider, the first service provider providing the predetermined service to the domain registrant;
a TLD registry, the domain registrant registering a domain name with the TLD registry, wherein the TLD registry requires the domain registrant to use the first service provider for the predetermined service;
a service implementer, the service implementer comprising one or more of:
a first TLD Registry DNS server, the first TLD Registry DNS server configured to return a first DNS result in response to a DNS query sent to the first TLD Registry DNS service, wherein the DNS query is a request for a service provider of the predetermined service for the domain name, the first DNS result comprising one or more DNS records corresponding to one or more servers of the first service provider;
a second TLD Registry DNS server, the second TLD Registry DNS server configured to delegate a DNS of the domain name to a first set of name servers controlled by one or more of the TLD registry and the first service provider, wherein the first set of name servers return the first DNS result in response to a DNS query for a service provider of the predetermined service; and
a monitoring module, the monitoring module configured to monitor if a DNS response of the domain name for the predetermined service is the first DNS result, wherein a DNS of the domain name is managed by the domain registrant.

21. The system of claim 20, wherein the service implementer further comprises one or more of an interface setting and an Application Programming Interface (API) query to allow a domain registrant to opt out of the predetermined service.

22. The system of claim 20, wherein the first service provider is one or more of the TLD registry and an independent service provider.

23. The system of claim 20, wherein the service implementer is further configured to disallow the domain registrant from modifying one or more of the first DNS result and the delegation.

24. The system of claim 20, wherein the service implementer gives an option to the domain registrant to enter one or more DNS records in the first set of name servers, wherein one or more of the first DNS result is irreplaceable by the one or more DNS records and the first DNS result has a higher priority than the one or more DNS records.

25. The system of claim 20, wherein the first TLD Registry DNS server is further configured to:
return a second set of name servers for a query that is different from the DNS query for the predetermined service, wherein the second set of name servers are controlled by the domain registrant.

26. The system of claim 20, wherein in the first TLD Registry DNS server, the second TLD Registry DNS server and the monitoring module is operatively coupled to one or more of a TLD registry server, an independent server, a separate computing device, the first service provider and a program.

27. The system of claim 20, wherein, if the DNS Response is not same as the first DNS result, then the monitoring module is configured to perform one or more of:
sending a notification to the domain registrant to change the DNS Response to the first DNS result;
suspending the domain name registered by the domain registrant from the TLD registry; and
levying an extra charge for the domain name registered by the domain registrant.

28. The system of claim 20, wherein one or more of the TLD registry and the first service provider generates a revenue from the predetermined service by performing one or more of:
displaying one or more commercial content to one or more users of the service;
clicking on one or more commercial content by the one or more users of the service; and
charging the domain registrant for the service.

29. The system of claim 28, wherein if the first service provider generates the revenue, the first service provider gives the TLD registry a commission in form-of one or more of a revenue share and a fixed fee, for each domain name that uses the predetermined service.

30. The system of claim 29, wherein the first service provider maintains a periodic report of the commission.

31. The system of claim 30, wherein the first service provider generates the periodic report for each domain name using the revenue generated by the each domain name.

32. The system of claim 30, wherein the periodic report enables one or more of the TLD registry and the first service provider to share the revenue with a Registrar, wherein the domain registrant registers the domain name with the TLD registry through the Registrar.

33. The system of claim 32, wherein to enable the first service provider to share the revenue with the Registrar, the TLD Registry performs one or more of:
providing the first service provider with an indication of one or more of a set of domain names belonging to the Registrar, a period for which the set of domain names belong to the Registrar, and a percentage of the revenue earned out of the set of domain names to be paid to the Registrar;
calculate a revenue share for the Registrar based on a revenue share algorithm; and
determine an absolute revenue for each Registrar.
